(19) United States
(12) Patent Application Publication
(10) Pub. No.: US 2016/0026436 A1
(43) Pub. Date: Jan. 28, 2016

(54) Dynamic Multi-processing In Multi-core Processors

(71) Applicant: QUALCOMM Incorporated, San Diego, CA (US)

(72) Inventor: Jian Shen, San Diego, CA (US)

(21) Appl. No.: 14/339,844

(22) Filed: Jul. 24, 2014

(51) Int. Cl. G06F 5/14; G06F 9/38

(52) U.S. Cl. CPC G06F 5/14; G06F 9/3867; G06F 2205/126

(57) ABSTRACT

Aspects include computing devices, systems, and methods for implementing a pipeline multi-processing (PMP) mode on a computing device using a common FIFO unit. The computing device may use configuration information for the PMP mode to allocate FIFO components of the common FIFO unit to input write data from and output read data to specific processor cores. At least first and second processor cores may be allocated a FIFO component. The first processor core may request to input write data to the FIFO component and the second processor core may request to output the read data from the FIFO component. The allocation of the FIFO components may be static and/or dynamic. FIFO access request may be denied when the common FIFO unit is already executing a similar FIFO access request, or when the FIFO components are either full and cannot input write data or empty an cannot output read data.

### BACKGROUND

There are three modes in which software can run on a multi-core system. In symmetric multi-processing (SMP) mode any task can run on any processor core independently under the control of the operating system. Asymmetric multi-processing (AMP) mode allows for different tasks to run on specific processor cores of various architectures that are best suited for the tasks. In pipeline multi-processing (PMP) mode a software task is divided into sequential sub-tasks, and each sub-task runs on a separate processor core in a pipeline fashion, with intermediate results passed from one processor core to the next. Existing homogeneous multi-core architectures (e.g. quad-core ARM CPUs) accommodate and implement SMP mode because each of the homogeneous processor cores can perform each task equivalently. Heterogeneous multi-core architectures (e.g. a computing device including an ARM® processor and a digital signal processor (DSP)) accommodate and implement AMP mode, because the different cores are better suited for specific tasks, and thus cannot perform the tasks equivalently.

Neither homogeneous nor heterogeneous multi-core architectures can efficiently implement PMP mode. Existing solutions for implementing a PMP mode on multi-core architectures include intermediate processing of information passed between the cores via main memory, which negatively impacts power consumption (due to the large number of memory writes & reads) and performance (due to latency added by the memory write & read operations). Other solutions include intermediate processing of information passed between cores via cache memory, which adds costs in terms of coherency hardware and potential for evicting other programs' data out of the cache. Another solution includes passing intermediate processed information between cores via dedicated First In First Out (FIFO) stacks, in which each FIFO stack is configured for passing information between a particular pair of cores with no flexibility to accommodate PMP pipeline order or depth changes.

### SUMMARY

The methods and apparatuses of various aspects provide circuits and methods for enabling computing devices having homogeneous and heterogeneous multi-core architectures to perform in a pipeline multi-processing (PMP) mode. In various aspects a multi-processor computing device, which may be system-on-chip, may include a common first in, first out (FIFO) unit having a plurality of FIFO components and a switch configure to allocate selected FIFO components to selected processor cores. Various aspects include a method, which may be implemented in the FIFO unit in circuitry and/or with a processor configured with processor-executable instructions to perform the method, that includes receiving configuration information for a pipeline multi-processing mode, allocating a first FIFO component of the plurality of FIFO components to a first processor core for executing a first function including one of inputting write data or outputting read data in accordance with the received configuration information such that the first FIFO component is also allocated to a second processor core for executing a second function including the other of inputting write data or outputting read data, receiving FIFO access requests from the first and second processor cores, and executing the first and second functions using the allocated FIFO component in response to receiving FIFO access requests from the first and second processor cores. In some aspects, the method may further include, and the FIFO unit may be configured to perform further operations including, allocating a second FIFO component of the plurality of FIFO components to the first processor core for executing the first function in accordance with the configuration information, and allocating the second FIFO component to the second processor core for executing the second function in accordance with the configuration information. In some aspects, the method may further include, and the FIFO unit may be configured to perform further operations including, allocating a second FIFO component of the plurality of FIFO components to a third processor core for a third function including one of inputting write data or outputting read data in accordance with the received configuration information such that the first function and the third function both include the same of inputting write data or outputting read data, and such that the second FIFO component is also allocated to the second processor core for executing the second function.

In some aspects, the FIFO unit may be configured such that receiving FIFO access requests from the first and second processor cores includes receiving a first FIFO access request from the first or second processor core, determining whether the common FIFO component can handle a first FIFO access request, and denying the first FIFO access request in response to determining that the common FIFO component cannot handle the first FIFO access request.

In some aspects, the FIFO unit may be configured such that determining whether the common FIFO component can handle a first FIFO access request includes determining whether the common FIFO unit is already executing a second FIFO access request such that the first and second FIFO access requests specify the same one of inputting write data or outputting read, and determining that the common FIFO unit cannot handle the first FIFO access request in response to determining that the common FIFO unit is already executing the second FIFO access request specifying the same one of inputting write data or outputting read as the first FIFO access request.

In some aspects, determining whether the common FIFO component can handle a first FIFO access request may include determining a allocated FIFO component for a processor core issuing the first FIFO access request, determining whether the allocated FIFO component contains data in response to the first FIFO access request specifying outputting read data, determining whether the allocated FIFO component is full in response to the first FIFO access request specifying inputting write data, and determining that the common FIFO component cannot handle the first FIFO access request in response to determining the allocated FIFO component does not contain data or the allocated FIFO component is full.

In some aspects, denying the first FIFO access request in response to determining that the common FIFO component cannot handle the first FIFO access request may include generating a return signal configured to notify a processor core issuing the first FIFO access request that the first FIFO access request is denied.

In some aspects, the method may further include, and the FIFO unit may be configured to perform further operations including, receiving further configuration information for the pipeline multi-processing mode, allocating the first FIFO component to a third processor core of the plurality of processor cores for executing a third function including one of inputting write data or outputting read data in accordance with the received further configuration information, such that allocating the first FIFO component to the third processor core replaces allocating the first FIFO component to the first processor core, and such that the first FIFO component is also allocated to the second processor core for executing the second function including the other of inputting write data or outputting read data, receiving FIFO access requests from the second and third processor cores, and executing the second and third functions using the allocated FIFO component in response to receiving FIFO access requests from the second and third processor cores.

Various aspects include a computing device having means for performing functions of the aspect methods described above. Various aspects also include a non-transitory processor-readable storage medium on which is stored processor-executable instructions configured to cause a processor, such as a processor within or coupled to the FIFO unit, to perform operations of the aspect methods described above.

### BRIEF DESCRIPTION OF THE DRAWINGS

The accompanying drawings, which are incorporated herein and constitute part of this specification, illustrate example aspects of the invention, and together with the general description given above and the detailed description given below, serve to explain the features of the invention.

FIG. 1 is a component block diagram illustrating a computing device suitable for implementing an aspect.

FIG. 2 is a component block diagram illustrating an example multi-core processor suitable for implementing an aspect.

FIG. 3 is a component block diagram illustrating numerous processor cores in communication with a common FIFO unit configurable to variably implement a pipeline multi-processing mode with at least some of the processor cores in accordance with an aspect.

FIG. 4 is a component block diagram illustrating a common FIFO unit configurable to variably implement a pipeline multi-processing mode with various processor cores in accordance with an aspect.

FIG. 5 is a component block diagram illustrating a common FIFO unit configurable to variably implement a pipeline multi-processing mode with various processor cores in accordance with an aspect.

FIG. 6 is a component block diagram illustrating a common FIFO unit configurable to variably implement a pipeline multi-processing mode with various processor cores in accordance with an aspect.

FIG. 7 is a component block diagram illustrating a common FIFO unit configurable to variably implement a pipeline multi-processing mode with various processor cores in accordance with an aspect.

FIG. 8 is a process flow diagram illustrating an aspect method for variably implementing a pipeline multi-processing mode.

FIG. 9 is a process flow diagram illustrating an aspect method for configuring a computing device for variably implementing a pipeline multi-processing mode.

FIG. 10 is a component block diagram illustrating a configuration of various processor cores and various FIFO components for implementing a pipeline multi-processing mode in accordance with an aspect.

FIG. 11 is a component block diagram illustrating a configuration of various processor cores and various FIFO components for implementing a pipeline multi-processing mode in accordance with an aspect.

FIG. 12 is a component block diagram illustrating a configuration of various processor cores and various FIFO components for implementing a pipeline multi-processing mode in accordance with an aspect.

FIG. 13 is a component block diagram illustrating a configuration of various processor cores and various FIFO components for implementing a pipeline multi-processing mode in accordance with an aspect.

FIG. 14 is a component block diagram illustrating a configuration of various processor cores and various FIFO components for implementing a pipeline multi-processing mode in accordance with an aspect.

FIG. 15 is a component block diagram illustrating a configuration of various processor cores and various FIFO components for implementing a pipeline multi-processing mode in accordance with an aspect.

FIG. 16 is a component block diagram illustrating a configuration of various processor cores and various FIFO components for implementing a pipeline multi-processing mode in accordance with an aspect.

FIG. 17 is a process flow diagram illustrating an aspect method for avoiding deadlock for variably implementing a pipeline multi-processing mode.

FIG. 18 is component block diagram illustrating an example mobile device suitable for use with the various aspects.

FIG. 19 is component block diagram illustrating an example mobile device suitable for use with the various aspects.

FIG. 20 is component block diagram illustrating an example server device suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “computing device” and “mobile device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices that include a memory, and a multi-core programmable processor. While the various aspects are particularly useful for mobile computing devices, such as smartphones, which have limited resources, the aspects are generally useful in any electronic device that implements a plurality of memory devices and a limited power budget where reducing the power consumption of the processors can extend the battery-operating time of the mobile computing device.

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASCI), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

In an aspect a pipeline multi-processing (PMP) mode for homogeneous and heterogeneous multi-core architectures may be efficiently accommodated and implemented, reducing the hardware and processing costs compared to previous attempts. A multi-core architecture that may be dynamically configured to implement symmetric multi-processing (SMP) or asymmetric multi-processing (AMP) modes, as well as a pipeline multi-processing mode, may include a common first in, first out (FIFO) memory or stack (referred to herein as a “FIFO unit”) in communication with each of the homogeneous or heterogeneous processor cores via a common communication bus. In symmetric multi-processing and asymmetric multi-processing modes the homogeneous and heterogeneous processor cores may implement the respective modes as known. In a pipeline multi-processing mode, the homogeneous or heterogeneous processor cores may be configured to pass intermediate processing information between themselves by reading and writing intermediate processing information from and to the common FIFO unit. The common FIFO unit may be a FIFO block or memory module including various FIFO components. The common FIFO unit may include at least two slave ports, including at least one read port and at least one write port. These slave ports may connect the common FIFO unit to the common communication bus, thereby allowing the processor cores to access the common FIFO unit. Because the common FIFO unit may be accessed by the different processor cores for intermediate processing data, there is less congestion on the common communication bus, and less bus arbitration because the nature of the FIFO unit controls the amount of intermediate processing data that can be accessed over the common communication bus and the order in which that intermediate processing data may be accessed by the processor cores.

The number of FIFO components included in the common FIFO unit may be configurable to allow for less or greater FIFO depth. In an aspect the number of FIFO components in the common FIFO unit may be configured to accommodate the number of processor cores accessing the common FIFO unit. For example, the number of processor cores accessing the common FIFO unit and the number of FIFO components may be the same. In an aspect, the common FIFO unit may include a single FIFO component, or multiple FIFO components and be configured to behave as if it only contained a single FIFO component.

In an aspect, fewer than all of the processor cores may implement the pipeline multi-processing mode. The number of processor cores used to implement the pipeline multi-processing mode may dictate the number of FIFO components included or activated in the common FIFO unit. For example, a single FIFO component may be included or activated in the common FIFO unit when only two of multiple processor cores implement pipeline multi-processing mode.

Each processor cores may write to one or more FIFO components and the common FIFO unit may be configured to variably allow access to the data stored in each individual FIFO component, depending on a predetermined processing scheme or dynamic requests for the data from the individual processor cores. In an aspect, the common FIFO unit may include a switch to allocate or direct the output of each FIFO component to a particular processor core, either by the predetermined processing scheme or dynamic request. The common FIFO unit may also include an arbiter, which may include a multiplexer configured for controlling when the information stored to each FIFO component is output to the common communication bus and the corresponding processor core. In an aspect, for the common FIFO unit having or activating only one FIFO component, similar components and schemes may be implemented to direct the outputs of the single FIFO unit to the correct processor cores (i.e., the processor cores to which the FIFO component has be allocated). In such an aspect, rather than matching and controlling multiple FIFO outputs to multiple processor cores, the common FIFO unit may control a single FIFO output to multiple processor cores. Aspects of the common FIFO unit having multiple FIFO components may employ smaller FIFO components than aspects having fewer or a single FIFO component.

In an aspect, to avoid deadlock, for example by concurrent reads from and writes to the same common FIFO unit, a sideband signal from a controller to a processor core may be included to indicate when the common FIFO unit is being accessed by another processor core. When a particular FIFO component does not contain information, the read requests to the FIFO component may be postponed until the sideband signal indicates the FIFO component contains data. This may allow writing to the FIFO unit without having to wait for a stalled read request when the FIFO component is empty. Similarly, the common FIFO unit may include a master port to similarly signal to the processor cores when to make requests from the common FIFO unit.

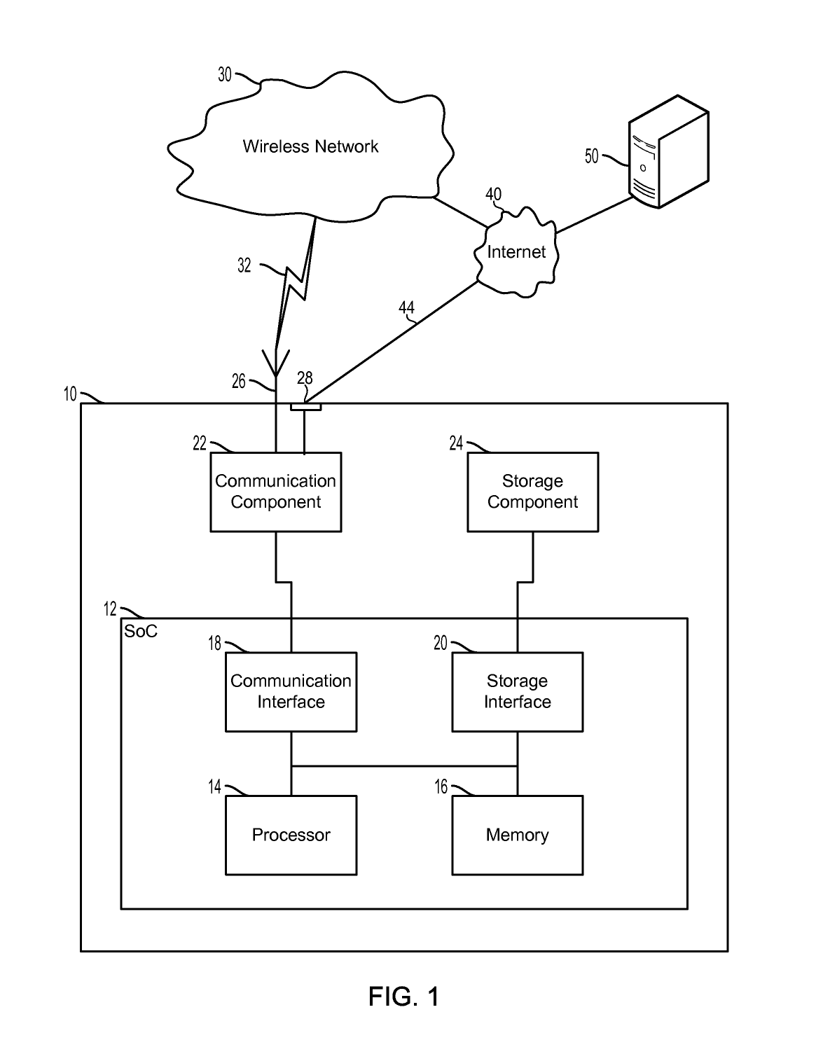

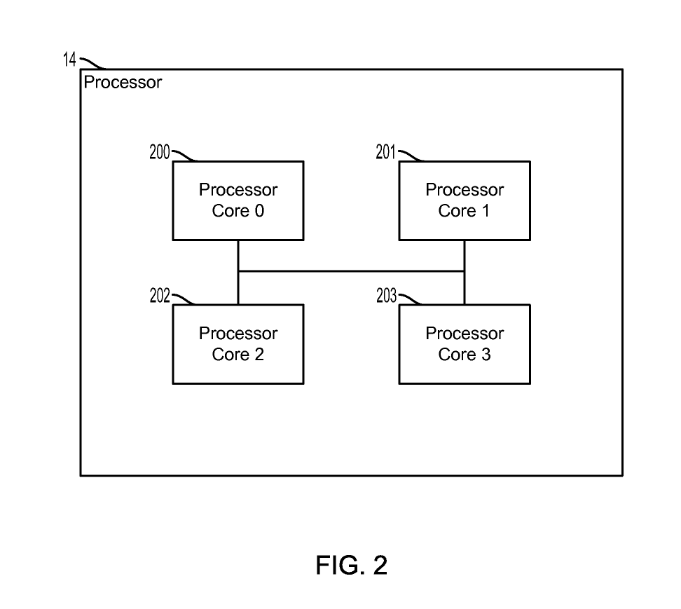

FIG. 1 illustrates a system including a computing device 10 in communication with a remote computing device 50 suitable for use with the various aspects. The computing device 10 may include an SoC 12 with a processor 14, a memory 16, a communication interface 18, and a storage interface 20. The computing device may further include a communication component 22 such as a wired or wireless modem, a storage component 24, an antenna 26 for establishing a wireless connection 32 to a wireless network 30, and/or the network interface 28 for connecting to a wired connection 44 to the Internet 40. The processor 14 may include any of a variety of hardware cores, as well as a number of processor cores. The SoC 12 may include one or more processors 14. The computing device 10 may include more than one SoCs 12, thereby increasing the number of processors 14 and processor cores. The computing device 10 may also include processor 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together.

The memory 16 of the SoC 12 may be a volatile or non-volatile memory configured for storing data and processor-executable code for access by the processor 14. In an aspect, the memory 16 may be configured to store data structures at least temporarily, such as intermediate processing data output by one or more of the processors 14. In an aspect, the memory 16 may be configured to store information for configuring a common FIFO unit (not shown) to implement a various processing modes of the processors 14, including a pipeline multi-processing mode. The memory 16 may include non-volatile read-only memory (ROM) in order to retain the information for configuring the common FIFO unit.

The computing device 10 and/or SoC 12 may include one or more memories 16 configured for various purposes. In an aspect, one or more memories 16 may be configured to be dedicated to storing the information for configuring the common FIFO unit. The memory 16 may store the information in a manner that enables the information to be accessed by the processor executing a kernel or scheduler that selects the various processing modes and configurations of the common FIFO unit in order to implement the pipeline multi-processing mode for all or a group of the processor cores of the computing device.

The communication interface 18, communication component 22, antenna 26, and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50.

The storage interface 20 and the storage component 24 may work in unison to allow the computing device 10 to store data on a non-volatile storage medium. The storage component 24 may be configured much like an aspect of the memory 16 in which the storage component 24 may store the information for configuring the common FIFO unit, such that information may be accessed by one or more processors 14. The storage component 24, being non-volatile, may retain the information even after the power of the computing device 10 has been shut off. When the power is turned back on and the computing device 10 reboots, the information stored on the storage component 24 may be available to the computing device 10. The storage interface 20 may control access to the storage device 24 and allow the processor 14 to read data from and write data to the storage device 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an aspect. The multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively.

Through variations in the manufacturing process and materials, the performance characteristics of homogeneous processor cores 200, 201, 202, 203, may differ from processor core to processor core within the same multi-core processor 14 or within another multi-core processor 14 using the same designed processor cores.

The processor cores 200, 201, 202, 203 may be heterogeneous in that, the processor cores 200, 201, 202, 203 of a single processor 14 may be configured for different purposes and/or have different performance characteristics. Example of such heterogeneous processor cores may include what are known as “big.LITTLE” architectures in which slower, low-power processor cores may be coupled with more powerful and power-hungry processor cores.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various aspects to a four-core processor system. The computing device 10, the SoC 12, or the multi-core processor 14 may individually or in combination include fewer or more than the four processor cores 200, 201, 202, 203 illustrated and described herein.

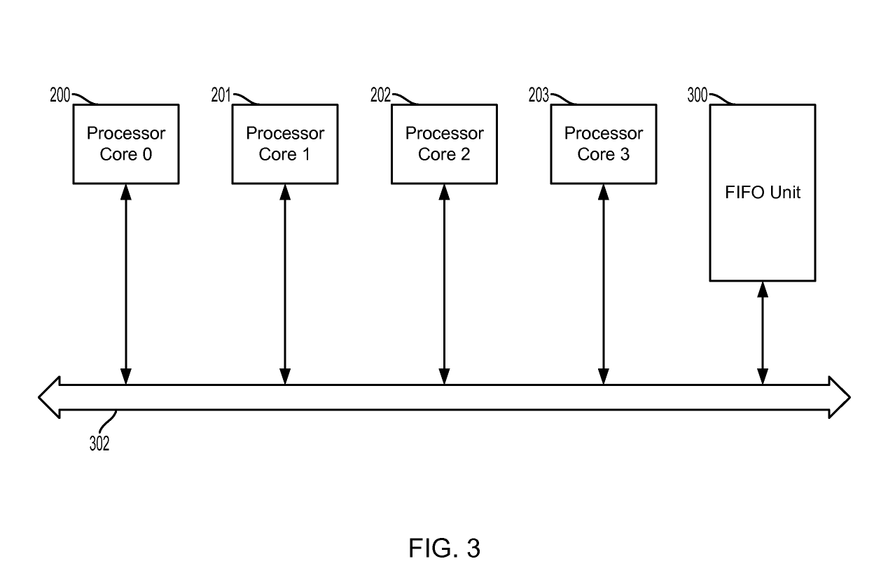

FIG. 3 illustrates four processor cores 200, 201, 202, 203 in communication with a common FIFO unit 300 configurable to variably implement a pipeline multi-processing mode with at least some of the processor cores in accordance with an aspect. The processor cores 200, 201, 202, and 203 may be in communication with the common FIFO unit 300 via a common communication bus 302. The processor cores 200, 201, 202, and 203 may be configured as masters of the common FIFO unit 300 and the common communication bus 302. Communications between the processor cores 200, 201, 202, and 203 and the common FIFO unit 300 via the common communication bus 302 may be bidirectional. The processor cores 200, 201, 202, and 203 may make read and write requests, or FIFO access requests, of the common FIFO unit 300 via the common communication bus 302. In an aspect, read requests issued by the processor cores 200, 201, 202, and 203 may be received by the common FIFO unit 300 via the common communication bus 302, and the common FIFO unit 300 may return the requested read data via the same bus 302. In an aspect, write requests, along with write data, issued by the processor cores 200, 201, 202, and 203 may be received by the common FIFO unit 300 via the common communication bus 302. The common FIFO unit 300 may store the received write data, and in an aspect may return a signal notifying the issuing processor core 200, 201, 202, and 203 of a successful write operation. Other communications, such a sideband signals for indicating to the processor cores 200, 201, 202, and 203 that the common FIFO unit 300 is busy may also be sent via the common communication bus 302. In an aspect, these sideband signals may be transmitted to the processor cores 200, 201, 202, and 203 via dedicated communication lines.

The processor cores 200, 201, 202, and 203 may be grouped together on a single processor and/or single SoC. In an aspect, the common FIFO unit 300 may be located on the same processor and/or SoC as the processor cores 200, 201, 202, and 203. In an aspect, the common FIFO unit 300 may be dedicated for use with the processor cores 200, 201, 202, and 203. In an aspect, the common FIFO unit 300 may be shared among numerous groups of processor cores 200, 201, 202, and 203 on the same processor and/or SoC. In an aspect the common FIFO unit 300 may be used with a disperse group of processor cores on different processors (not shown) and/or different SoCs (not shown). In an aspect, the processor cores 200, 201, 202, and 203 may communicate directly with the common FIFO units 300 of different processors and/or SoCs. In an aspect, communications between processor cores and common FIFO units on different processors and/or SoCs may be facilitated by a common FIFO unit on the same processor and/or SoC as the processor cores. In an aspect, multiple common FIFO units 300 may be included on a processor and/or SoC, and one or more of the common FIFO units 300 may be dedicated for uses with one or more specific groups of processor cores 200, 201, 202, and 203, or may be configured to be used with various groups of the processor cores 200, 201, 202, and 203 at different times.

In implementing a pipeline multi-processing mode, the common FIFO unit 300 may be configured to store and return data provided and requested by the processor cores 200, 201, 202, and 203 according to a designated pipeline multi-processing scheme. Such a scheme may allocate the specific data stored by a specific processor core 200, 201, 202, and 203 to the common FIFO unit 300 that may be accessed by the other processor cores 200, 201, 202, and 203. In an aspect, some of the processor cores 200, 201, 202, and 203 in the pipeline multi-processing mode may expect to receive intermediate processing data produced by another of the processor cores 200, 201, 202, and 203. The common FIFO unit 300 may be configured to respond to read requests from any of the processor cores 200, 201, 202, and 203 with the expected intermediate processing data produced by the appropriate processing core 200, 201, 202, and 203.

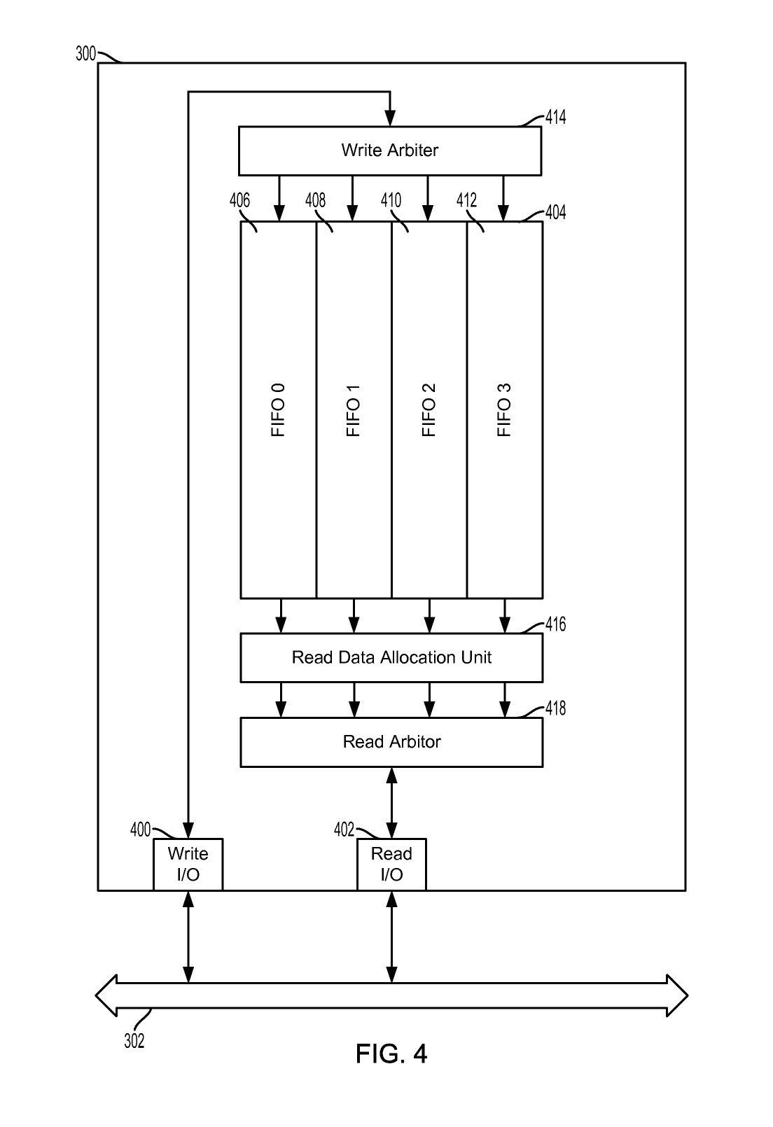

The common FIFO unit 300 may be configured according to a number of configurations in order to implement a pipeline multi-processing mode. In the examples illustrated in FIGS. 4-7, the FIFO block 404 includes four FIFO components 406, 408, 410, and 412 (i.e. FIFO 0, FIFO 1, FIFO 2, and FIFO 3). For ease of explanation, the examples illustrated in FIGS. 4-7 include the same FIFO components 406, 408, 410, and 412 as included in the examples illustrated in FIGS. 10-16, and references are made to the four FIFO components 406, 408, 410, and 412 illustrated in FIGS. 4-7 and 10-16. However, the four FIFO components 406, 408, 410, and 412 illustrated in FIGS. 4-7 and 10-16 and described herein are merely provided as examples and are not meant to limit the various aspects to a four-FIFO component system. The computing device 10, the SoC 12, the multi-core processor 14, or the common FIFO unit 300 may individually or in combination include fewer or more than the four FIFO components illustrated and described herein.

FIG. 4 illustrates an aspect configuration of the common FIFO unit 300 to variably implement a pipeline multi-processing mode with various processor cores. The common FIFO unit 300 may include a slave write input/output (I/O) port 400, a slave read input/output (I/O) port 402, a FIFO block 404, which may include one or more FIFO components 406, 408, 410, and 412, a write arbiter 414, a read data allocation unit 416, and a read arbiter 418. The write input/output port 400 and the read input/output port 402 may connect the common FIFO unit 300 to the common communication bus 302 and facilitate communication with the processor cores. The write input/output port 400 may receive FIFO write requests from the processor cores. The FIFO write request may include a master identifier (ID) and the write data to be stored in the common FIFO unit 300. In an aspect, the common FIFO unit 300 only includes one write input/output port 400 and may only execute one FIFO write request at a time. In response to receiving multiple FIFO write requests from one or more processor cores, the common FIFO unit 300 may return a signal via the write input/output port 400 or a dedicated master signaling port (not shown), and the common communication bus 302 or a dedicated signaling line (not shown), notifying all or just the requesting processor core that the common FIFO unit 300 cannot execute the requested FIFO write at the time. The processor cores receiving this notification may be prompted to resend the FIFO write request, or configured to wait for a designated period before sending any FIFO write request.

The write input/output port 400 may transmit the write request to the write arbiter 414. In an aspect, the write arbiter 414 may determine whether the common FIFO unit 300 may execute the received FIFO write requests. The write arbiter 414 may determine whether the common FIFO unit 300 is busy with another write request, or whether the FIFO component 406, 408, 410, and 412 allocated to a processor core for storing the write data is full. In an aspect, the FIFO components 406, 408, 410, and 412 may be designated to receive write data from a particular processor core (i.e., allocated to the particular processor core). The write arbiter 414 may be informed as to the FIFO component 406, 408, 410, and 412 that is allocated to a particular processor core. In an aspect, the master identifier received with the FIFO write request may identify the requesting processor core. In another aspect, the correlation between a master identifier and the allocated FIFO component 406, 408, 410, and 412 may be static. The write arbiter 414 may determine the status of the common FIFO unit 300 and/or the allocated FIFO component 406, 408, 410, and 412. Based on the determined status, the write arbiter 414 may determine whether to allow or reject the received FIFO write requests. In response to determining that a FIFO write request cannot be executed, the write arbiter 414 may cause the previously mentioned notification signal to be transmitted. In an aspect, the write arbiter 414 may store the FIFO write request in a queue for execution when the common FIFO unit 300 and/or the allocated FIFO component 406, 408, 410, and 412 are ready to execute the FIFO write request. In response to determining that a FIFO write request can be executed, the write arbiter 414 may transmit the write data to the allocated FIFO component 406, 408, 410, and 412.

The FIFO components 406, 408, 410, and 412 may be part of a FIFO block 404. The FIFO block 404 may be variably configured as described further herein. In the example in FIG. 4, the FIFO block 404 is configured such that each of the FIFO components 406, 408, 410, and 412 may be used individually. Each of the FIFO components 406, 408, 410, and 412 may be designated to receive write data from a particular processor core (i.e., allocated to the particular processor core). The FIFO components 406, 408, 410, and 412 may be of a predetermined size. Once one of the FIFO components 406, 408, 410, and 412 is filled with write data, the data stored in the full FIFO component 406, 408, 410, and 412 may be required to be readout before more data may be written to the full FIFO component 406, 408, 410, and 412. Because each FIFO component 406, 408, 410, and 412 may be allocated to a particular processor core, a full FIFO component 406, 408, 410, and 412 may affect the write request of the processor core that has been allocated the FIFO component. Regardless of whether other FIFO components 406, 408, 410, and 412 are full, a not full FIFO component 406, 408, 410, and 412 may continue to receive write data from the processor core to which it has been allocated. In other words, each FIFO component 406, 408, 410, and 412, to an extent may operate independently of the other FIFO components 406, 408, 410, and 412. However, as described above, the common FIFO unit 300 may only be able to execute one write request at a time. Even if a FIFO component 406, 408, 410, and 412 is capable of receiving write data, it may not receive write data while another FIFO component 406, 408, 410, and 412 is receiving write data.

Similar to the write input/output port 400, the read input/output port 402 may receive FIFO read requests from the processor cores. The FIFO read request may include a master identifier (ID). In an aspect, the common FIFO unit 300 only includes one read input/output port 400 and may only execute one FIFO read request at a time. In response to receiving multiple FIFO read requests from one or more processor cores, the common FIFO unit 300 may return a signal via the read input/output port 402 or a dedicated master signaling port (not shown), and the common communication bus 302 or a dedicated signaling line (not shown), notifying all or just the requesting processor core that the common FIFO unit 300 cannot execute the requested FIFO read at the time. The processor cores receiving this notification may be prompted to resend the FIFO read request, or configured to wait for a designated period before sending any FIFO read request.

The read input/output port 402 may transmit the read request to the read arbiter 418. In an aspect, the read arbiter 418 may determine whether the common FIFO unit 300 may execute the received FIFO read requests. The read arbiter 418 may determine whether the common FIFO unit 300 is busy with another read request, or whether the FIFO component 406, 408, 410, and 412 allocated to store the write data is empty. In an aspect, the FIFO components 406, 408, 410, and 412 may be allocated to output read data to a particular processor core. The read arbiter 418 may be informed about the FIFO component 406, 408, 410, and 412 that is allocated to a particular processor core. In an aspect, the master identifier received with the FIFO read request may identify the requesting processor core. In another aspect, the correlation between a master identifier and the allocated FIFO component 406, 408, 410, and 412 may be static or dynamic, and controlled by the read data allocation unit 416 as described further herein. The read arbiter 418 may determine the status of the common FIFO unit 300 and/or the allocated FIFO component 406, 408, 410, and 412. Based on the determined status, the read arbiter 418 may determine whether to allow or reject the received FIFO read requests. In response to determining that a FIFO read request cannot be executed, the read arbiter 418 may cause the previously mentioned notification signal to be transmitted. In an aspect, the read arbiter 418 may store the FIFO read request in a queue for execution when the common FIFO unit 300 and/or the allocated FIFO component 406, 408, 410, and 412 is ready to execute the FIFO read request. In response to determining that a FIFO read request can be executed, the read arbiter 418 may transmit the read data to the processor core to which the FIFO component has been allocated. In an aspect, the write arbiter 414 and the read arbiter 418 may be separate components or the same component with the capabilities to execute the functions of both the write arbiter 414 and the read arbiter 418.

The read data allocation unit 416 may be a configurable or programmable component such that the common FIFO unit 300 may allocate each FIFO component 406, 408, 410, and 412 to a specific processor core for accessing requested read data. In other words, in response to a processor core issued FIFO read request, the read data allocation unit 416 may be configured to match the master identifier of the requesting processor core with the allocated FIFO component 406, 408, 410, and 412. This allows the proper allocation of the read data from the allocated FIFO component 406, 408, 410, and 412 for responding to the read request. Unlike a FIFO write request as described in the example of FIG. 4, the FIFO components 406, 408, 410, and 412 allocated to any processor core may not always be the same. The read data allocation unit 416 may be instructed to allocate the FIFO components 406, 408, 410, and 412 to certain processor cores, and it may also change those allocations. In an aspect the allocations may be static. For example, not changing the allocations during a particular session of a login or execution of software on the computing device. In another aspect, the allocations may be dynamic, changing one or more times during similar sessions. The read data allocation unit 416 may inform the read arbiter 418 of the allocations of the FIFO components 406, 408, 410, and 412 to certain processor cores so that the read arbiter 418 may check whether the correct FIFO component 406, 408, 410, and 412 for the FIFO read request has data to output. As described above, when a FIFO component 406, 408, 410, and 412 is empty, the FIFO read request may be queued or the requesting processor core may be notified that the FIFO read request was unsuccessful.

In an aspect, the read data allocation unit 416 may allocate the FIFO components 406, 408, 410, and 412 to the processor cores in order to implement the pipeline multi-processing mode. Depending on allocations of the FIFO components 406, 408, 410, and 412 to particular processor cores, for accessing those processor cores' intermediate processing data (i.e. write data), the read data allocation unit 416 may implement a specified pipeline scheme. The specified pipeline scheme may indicate a relationship between processor cores requiring that a first processor core produce intermediate processing data, and a second processor core receive the first processor core's intermediate processing data for further processing. To implement the specified pipeline scheme, the FIFO component 406, 408, 410, and 412 allocated to the first processor core may be allocated to the second processor core by the read data allocation unit 416. In this manner the allocated FIFO component 406, 408, 410, and 412 receives and stores the intermediate processing data from the first processor core, and outputs the intermediate processing data as read data to the designated second processor core. The read data allocation unit 416 may create a chain of processor cores such that the designated processor cores may read intermediate processing data of other processor cores from FIFO components 406, 408, 410, and 412 in an order indicated by the specified pipeline scheme. In an aspect, the read data allocation unit 416 may allocate one FIFO component 406, 408, 410, and 412 to one processor core, multiple FIFO components 406, 408, 410, and 412 to one processor core, one FIFO component 406, 408, 410, and 412 to multiple processor cores, or any combination thereof.

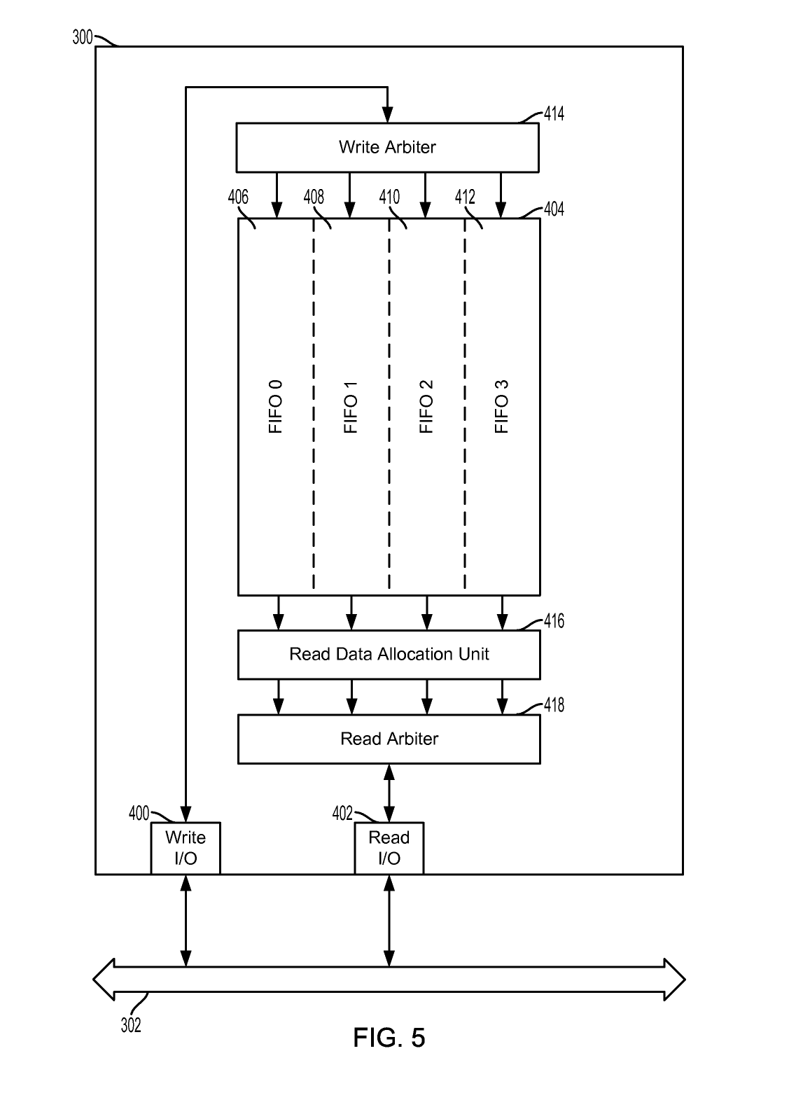

FIG. 5 illustrates an aspect configuration of the common FIFO unit 300 to variably implement a pipeline multi-processing mode with various processor cores. The common FIFO unit 300 may include the slave write input/output (I/O) port 400, the slave read input/output (I/O) port 402, the write arbiter 414, the read data allocation unit 416, and the read arbiter 418, as described above. The common FIFO unit 300 may further include the FIFO block 404, which may include one or more FIFO components 406, 408, 410, and 412. In this example, the FIFO block 404 may be configured such that the FIFO components 406, 408, 410, and 412 act as a combination of FIFO components fewer than the total number of the FIFO components 406, 408, 410, and 412. For example, the FIFO block 404 may be configured such that the FIFO components 406, 408, 410, and 412 act as a single, larger FIFO component. In another example, the FIFO components 406 and 408 may act as one FIFO component, the FIFO component 410 may be inactive, and the FIFO component 412 may act as a single FIFO component separate from the FIFO components 406 and 408. In such an example the FIFO components 406, 408, 410, and 412 act as two separate FIFO components, one larger than and one the same size as one of the FIFO components 406, 408, 410, and 412. The FIFO block 404 may be configured to use any one or group of FIFO components 406, 408, 410, and 412 in any combination.

Much like the example in FIG. 4, the read data allocation unit 416 may control the configuration of the FIFO block 404 by allocating the FIFO components 406, 408, 410, and 412 to certain processor cores for the purpose of reading data. To combine a group of the FIFO components 406, 408, 410, and 412 to act as one FIFO component, the read data allocation unit 416 may allocate more than one of the FIFO components 406, 408, 410, and 412 to the same processor core. The common FIFO unit 300 may keep track of the order in which these allocated FIFO components 406, 408, 410, and 412 are written to and read from. The read data allocation unit 416 and the read arbiter 418 may use the tracking data to determine when to allow a read request and allocate read data from one of the FIFO components 406, 408, 410, and 412 in the correct order. For example, the FIFO components 406 and 408 may be written to by a first and second processor core respectively. The pipeline scheme may dictate that the intermediate processing data from the first and second processor core be received by a third processor core. The common FIFO unit 300 may track the order in which the FIFO components 406 and 408 are written to by their respective processor cores. In response to receiving a FIFO read request from the third processor core, the read data allocation unit 416 may note which of the FIFO components 406 and 408 was written to earlier. The read data allocation unit 416 may allocate the data from that FIFO component 406 and 408 that was written to earlier as the read data for the FIFO read request. This process may repeat for each FIFO read request from the third processor core.

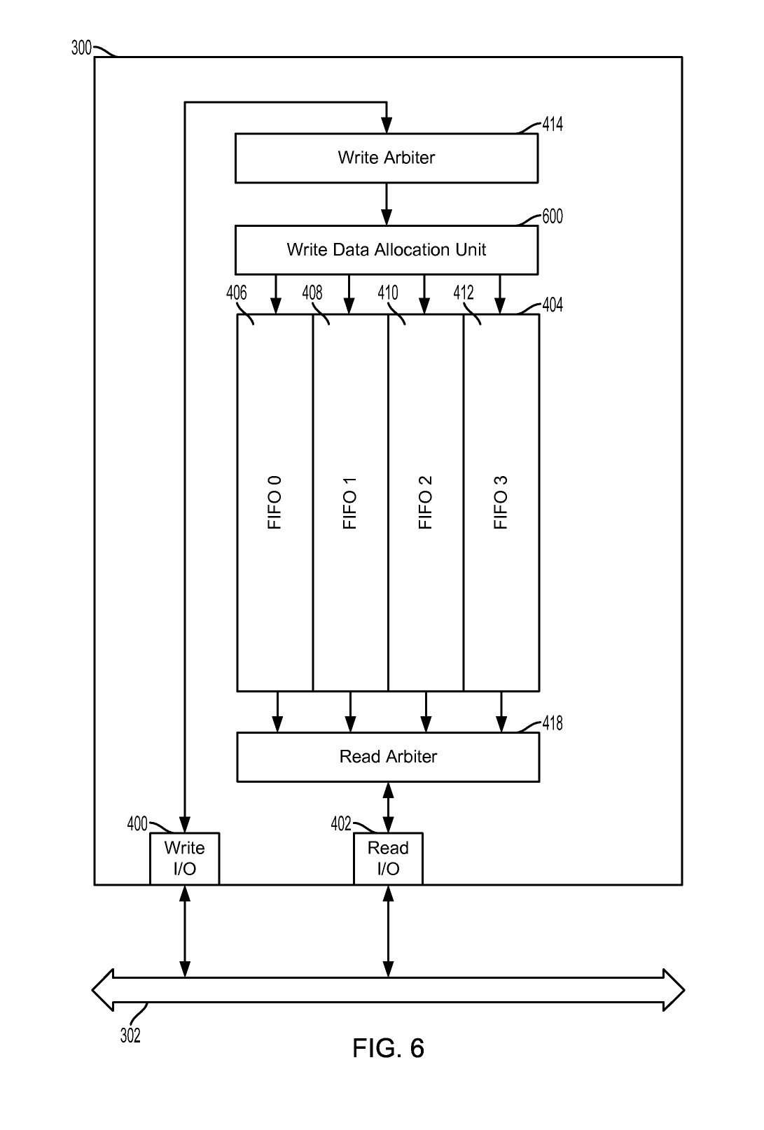

FIG. 6 illustrates an aspect configuration of the common FIFO unit 300 to variably implement a pipeline multi-processing mode with various processor cores. The common FIFO unit 300 may include the slave write input/output (I/O) port 400, the slave read input/output (I/O) port 402, the FIFO block 404, which may include one or more FIFO components 406, 408, 410, and 412, the write arbiter 414, and the read arbiter 418, as described above. The example in FIG. 6 differs from the examples in FIGS. 4 and 5 in that rather than including the read data allocation unit 416, the common FIFO unit 300 includes a write data allocation unit 600. Rather than allocating the FIFO components 406, 408, 410, and 412 to specific processor cores to output read data, the write data allocation unit 600 may allocate the FIFO components 406, 408, 410, and 412 to specific processor cores to input write data. Without the read data allocation unit 416, the allocations of the FIFO components 406, 408, 410, and 412 to specific processor cores for outputting read data may be static.

The write data allocation unit 600 may be a configurable or programmable component such that the common FIFO unit 300 may allocate each FIFO component 406, 408, 410, and 412 to a specific processor core for allocating requested write data. In other words, in response to a processor core issued FIFO write request, the write data allocation unit 600 may be configured to match the master identifier of the requesting processor core with the allocated FIFO component 406, 408, 410, and 412. This allows the proper allocation of the write data to the allocated FIFO component 406, 408, 410, and 412 for responding to the write request. In this example, unlike a FIFO read request the FIFO components 406, 408, 410, and 412 allocated to any processor core may not always be the same. The write data allocation unit 600 may be instructed to allocate the FIFO components 406, 408, 410, and 412 to certain processor cores, and it may also change those allocations. In an aspect the allocations may be static. For example, not changing the allocations during a particular session of a login or executing software on the computing device. In another aspect, the allocations may be dynamic, changing one or more times during similar sessions. The write data allocation unit 600 may inform the write arbiter 414 of the allocations of the FIFO components 406, 408, 410, and 412 to certain processor cores so that the write arbiter 414 may check whether the correct FIFO component 406, 408, 410, and 412 for the FIFO write request has space to input the data. As described above, when a FIFO component 406, 408, 410, and 412 is full, the FIFO write request may be queued or the requesting processor core may be notified that the FIFO write request was unsuccessful.

In an aspect, the write data allocation unit 600 may allocate the FIFO components 406, 408, 410, and 412 to the processor cores in order to implement the pipeline multi-processing mode. Depending on associations of the FIFO components 406, 408, 410, and 412 to particular processor cores, for outputting those processor cores' intermediate processing data (i.e. read data), the write data allocation unit 600 may implement a specified pipeline scheme. The specified pipeline scheme may indicate a relationship between processor cores requiring that a first processor core produce intermediate processing data, and a second processor core receive the first processor core's intermediate processing data for further processing. To implement the specified pipeline scheme, the write data allocation unit 600 may allocate the FIFO component 406, 408, 410, and 412 allocated to the second processor core to the first processor core. In this manner the allocated FIFO component 406, 408, 410, and 412 receives and stores the intermediate processing data from the first processor core, and outputs the intermediate processing data as read data to the second processor core. The write data allocation unit 600 may create a chain of processor cores such that the processor cores may read intermediate processing data of other processor cores from FIFO components 406, 408, 410, and 412 in an order indicated by the specified pipeline scheme. In an aspect, the write data allocation unit 600 may allocate one FIFO component 406, 408, 410, and 412 to one processor core, multiple FIFO components 406, 408, 410, and 412 to one processor core, one FIFO component 406, 408, 410, and 412 to multiple processor cores, or any combination thereof.

In an aspect, like the example in FIG. 5, the FIFO block 404 may be configured such that the FIFO components 406, 408, 410, and 412 act as a combination of FIFO components fewer than the total number of the FIFO components 406, 408, 410, and 412. The FIFO block 404 may be configured to use any one or group of FIFO components 406, 408, 410, and 412 in any combination. The write data allocation unit 600 may control the configuration of the FIFO block 404 by allocating the FIFO components 406, 408, 410, and 412 to certain processor cores for writing data. To combine a group of the FIFO components 406, 408, 410, and 412 to act as one FIFO component, the write data allocation unit 600 may allocate more than one of the FIFO components 406, 408, 410, and 412 to the same processor core. The common FIFO unit 300 may keep track of the order in which these allocated FIFO components 406, 408, 410, and 412 are written to and read from. The write data allocation unit 600 and the write arbiter 414 may use the tracking data to determine when to allow a write request and allocate write data to one of the FIFO components 406, 408, 410, and 412 in the correct order. For example, the FIFO components 406 and 408 may be written to by a first processor core. The pipeline scheme may dictate that the intermediate processing data from the first processor core be received by a second and third processor core in order. The common FIFO unit 300 may track the order in which the FIFO components 406 and 408 are read by their respective processor cores. In response to receiving a FIFO write request from the first processor core, the write data allocation unit 600 may note which of the FIFO components 406 and 408 was read from earlier. The write data allocation unit 600 may allocate the write data for the FIFO write request to the FIFO component 406 and 408 that was read from earlier. This process may repeat for each FIFO write request from the first processor core.

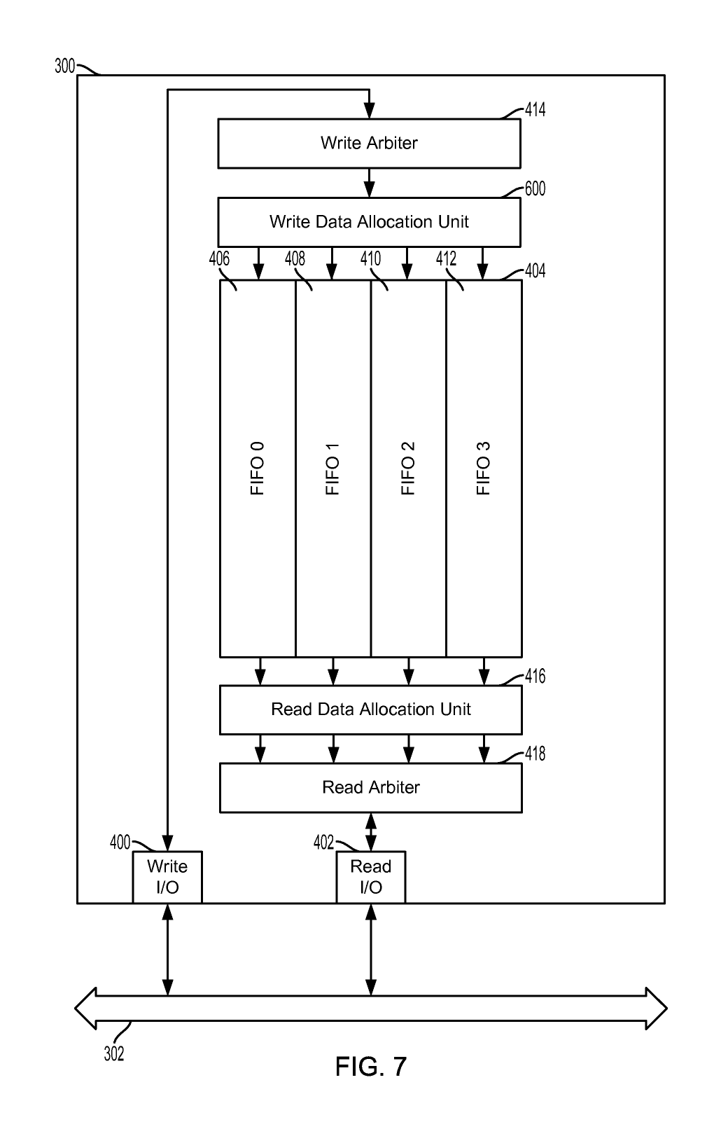

FIG. 7 illustrates an aspect configuration of the common FIFO unit 300 to variably implement a pipeline multi-processing mode with various processor cores. The common FIFO unit 300 may include the slave write input/output (I/O) port 400, the slave read input/output (I/O) port 402, the FIFO block 404, which may include one or more FIFO components 406, 408, 410, and 412, the write arbiter 414, write data allocation unit 600, the read data allocation unit 416, and the read arbiter 418, as described above. The example in FIG. 7 differs from the examples in FIGS. 4-6 in that the FIFO unit 300 may include the read data allocation unit 416 and the write data allocation unit 600. The FIFO components 406, 408, 410, and 412 may be allocated to specific processor cores to input write data and to output read data. With both the write data allocation unit 600 and the read data allocation unit 416, the allocations of the FIFO components 406, 408, 410, and 412 to specific processor cores for inputting write data and outputting read data may be static or dynamic. The write data allocation unit 600 and the read data allocation unit 416 may individually functions as described above. The write data allocation unit 600 and the read data allocation unit 416 may work in conjunction to allocate the FIFO components 406, 408, 410, and 412 to specific processor cores for inputting write data and outputting read data in order to implement the pipeline multi-processing mode. In an aspect the write data allocation unit 600 and the read data allocation unit 416 may each allocate one FIFO component 406, 408, 410, and 412 to one processor core, multiple FIFO components 406, 408, 410, and 412 to one processor core, one FIFO component 406, 408, 410, and 412 to multiple processor cores, multiple FIFO components 406, 408, 410, and 412 to multiple processor cores, or any combination thereof. In an aspect, like the example in FIG. 5, the FIFO block 404 may be configured such that the FIFO components 406, 408, 410, and 412 act as a combination of FIFO components fewer than the total number of the FIFO components 406, 408, 410, and 412. The FIFO block 404 may be configured to use any one or group of FIFO components 406, 408, 410, and 412 in any combination. In an aspect, the write data allocation unit 600 and the read data allocation unit 416 may be separate components or the same component with the capabilities to execute the functions of both the write data allocation unit 600 and the read data allocation unit 416.

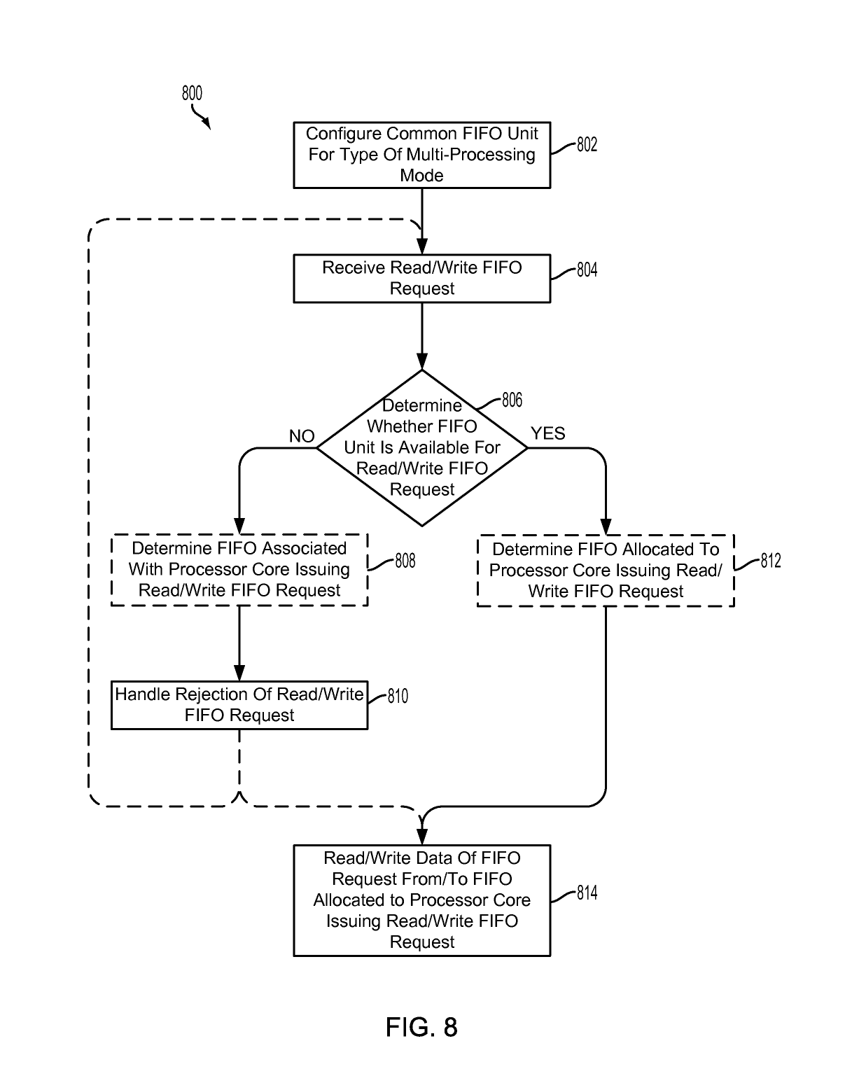

FIG. 8 illustrates an aspect method 800 for variably implementing a pipeline multi-processing mode. The method 800 may be executed in a computing device using software, general purpose or dedicated hardware, or a combination of software and hardware. In block 802 the common FIFO unit may be configured to implement a type of a multi-processing mode. The type of multi-processing mode may be one or a combination of the symmetric multi-processing mode, the asymmetric multi-processing mode, and the pipeline multi-processing mode. Configuring the common FIFO unit to implement one or more of these multi-processing modes may include instructing the read and/or write data allocation unit(s) to allocate one or more FIFO components of the common FIFO unit to one or more processor cores of the computing device. The read and/or write data allocation unit(s) may allocate the FIFO components to the processor cores according to a schemes for implementing the multi-processing modes. In an aspect, the schemes may be provided by a software program running on the computing device. In an aspect, the schemes may be selected from a memory device in response to a state on the computing device. The state may include a state of the computing device, a state of one or more of the components of the computing device, or a state of a software program.

In block 804, the common FIFO unit may receive a read or write FIFO request. The read or write FIFO request may include an instruction to either read from the common FIFO unit or to write to the common FIFO unit, and a master identifier to identify the processor core issuing the request. The write FIFO request may also include the intermediate processing data, or write data, to be written to the common FIFO unit. No identification of any memory address or FIFO component is necessary for these requests because the common FIFO unit is configured with allocated combinations of FIFO components and processor cores. These allocations allow the common FIFO unit to correctly store the write data and return the read data.

In determination block 806, the common FIFO unit may determine whether it is available for the read or write FIFO request. As discussed further herein, under certain circumstances, the common FIFO unit may be unable to handle a request to input data to or output data from its FIFO components. In response to determining that the common FIFO unit is unavailable for the read or write FIFO request (i.e. determination block 806=“No”), the common FIFO unit may determine which FIFO component is allocated to the processor core issuing the read or write FIFO request in optional block 808. As discussed herein, the read or write FIFO request may include a master identifier for the processor core issuing the read or write FIFO request. The common FIFO unit may be configured such that it is aware of the processor core that is allocated a particular FIFO component for both writing to the FIFO component and reading from the FIFO component. The common FIFO unit may correlate the master identifier received from the processor core issuing the request with a static or dynamic allocation of a FIFO component. The correlation may be accomplished by locating the master identifier in a record associating the master identifier with the FIFO component. The records may be stored in a memory device of the computing device as described herein. In an aspect, the records may be stored in one or more registers of the common FIFO unit.

In block 810, the common FIFO unit may handle rejecting the read or write FIFO request in response to determining that it is unavailable for the read or write FIFO request. In an aspect, the common FIFO unit may handle the rejection by notifying the issuing processor core that the request is denied. The common FIFO unit may proceed to receive another read or write FIFO request in block 804. In an aspect, the common FIFO unit may handle the rejection by queuing the request until the common FIFO unit becomes available for the request. In block 814, the common FIFO unit may read data from or write data to the FIFO component allocated to the processor core issuing the read or write FIFO request.

In response to the determining that the common FIFO unit is available for the read or write FIFO request (i.e. determination block 806=“Yes”), the common FIFO unit may determine the FIFO component that is allocated to the processor core issuing the read or write FIFO request in optional block 812. Optional block 812 may be implemented in the same way as optional block 808 described above. As described herein, in various aspects the allocation of the FIFO component to a processor core may be static. In such aspects it may not be necessary to determine the FIFO component that is allocated to the issuing processor core as the data may be automatically routed to or from the allocated FIFO component without further intervention. In other aspects, the common FIFO unit may use the identification of the allocated FIFO component to route the data through configurable circuitry to or from the allocated FIFO component. In block 814, the common FIFO unit may read data from or write data to the FIFO component allocated to the processor core issuing the read or write FIFO request.

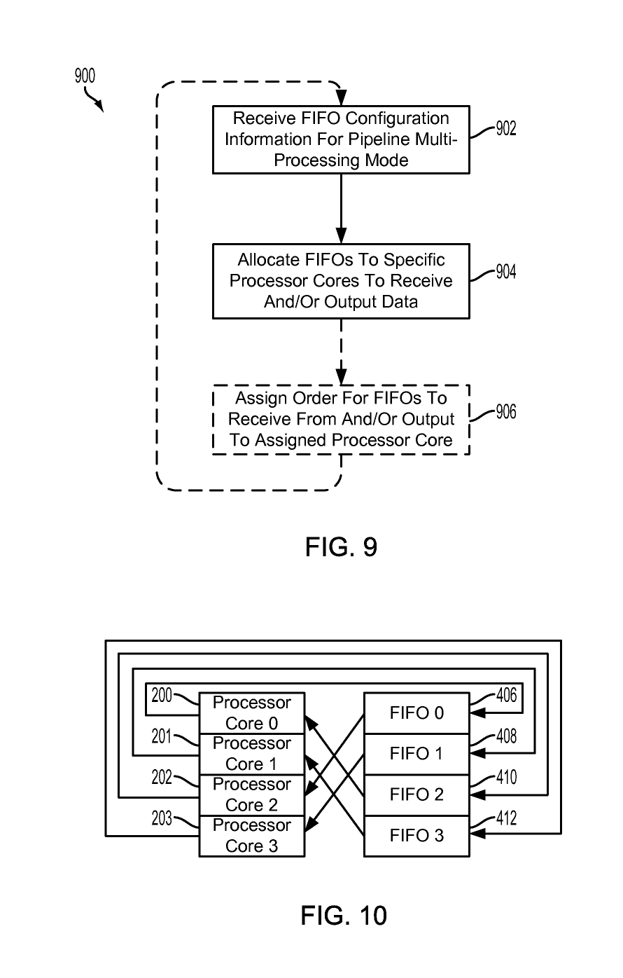

FIG. 9 illustrates an aspect method 900 for configuring a computing device for variably implementing a pipeline multi-processing mode. The method 900 may be executed in a computing device using software, general purpose or dedicated hardware, or a combination of software and hardware. In block 902, the common FIFO unit may receive FIFO configuration information for implementing a version of the pipeline multi-processing mode. The configuration information may indicate the FIFO components of the common FIFO unit to allocate to particular processor cores of the computing device. In an aspect, the configuration information may indicate the allocation of one or more FIFO components to one or more processor cores in any combination, examples of which are illustrated in FIGS. 10-16. In an aspect, the configuration may indicate the allocation of FIFO components to processor cores for inputting write data to the FIFO components from the processor cores and/or outputting read data from the FIFO components to the processor cores. In an aspect, configuration information for a pipeline multi-processing mode may require that at least a first FIFO component is allocated to a first processor core for writing and reading data. The configuration information may also allocate the first FIFO component to a second processor core for writing and reading data. In this aspect, only one of the allocations may be specified in the configuration information while the other allocation may be pre-allocated in the common FIFO unit, or both of the allocations may be specified by the configuration information.

In block 904, the common FIFO unit may allocate the FIFO components to the processor cores according to the configuration information. As described above, the allocation of the FIFO components to the processor cores may be implemented via configurable or programmable components, such as the read and write data allocation units. In an aspect, the common FIFO unit may include the read data allocation unit and may allocate FIFO components to processor cores for outputting read data to the processor cores. In an aspect, the common FIFO unit may include the write data allocation unit and may allocate FIFO components to processor cores for inputting write data from the processor cores. In either of these aspects, the read or write allocations not managed by the read or write data allocation units may be pre-allocated in the common FIFO unit. In an aspect, the common FIFO unit may include both a read and a write data allocation unit, which may be separate components or a single component.

In optional block 906, the common FIFO unit component may assign an order in which the FIFO components receive write data from and/or output read data to the processor cores. In an aspect, multiple FIFO components may be allocated to a single processor core, and the order in which the FIFO components are accessed by the processor core may be important. The configuration information may include an order for allowing access to the allocated FIFO components by the processor core. The common FIFO unit component may direct write and read instructions to the appropriate FIFO component based on the order specifications. Similarly, a single FIFO component may be allocated to multiple processor cores, and the order in which the processor cores access the FIFO component may be important. The common FIFO unit may control the order in which the processor cores access the FIFO component. In an aspect, the single FIFO component may also be multiple FIFO components acting as a single, larger FIFO component. In an aspect, where the FIFO configuration information may change, the common FIFO unit component may receive further FIFO configuration information in block 902.

FIGS. 10-16 illustrate various configurations of alignments of processor cores with FIFO components for implementing pipeline multi-processing modes. FIG. 10 illustrates one-to-one write and read allocations between the processor cores 200, 201, 202, and 203 and the FIFO components 406, 408, 410, and 412.

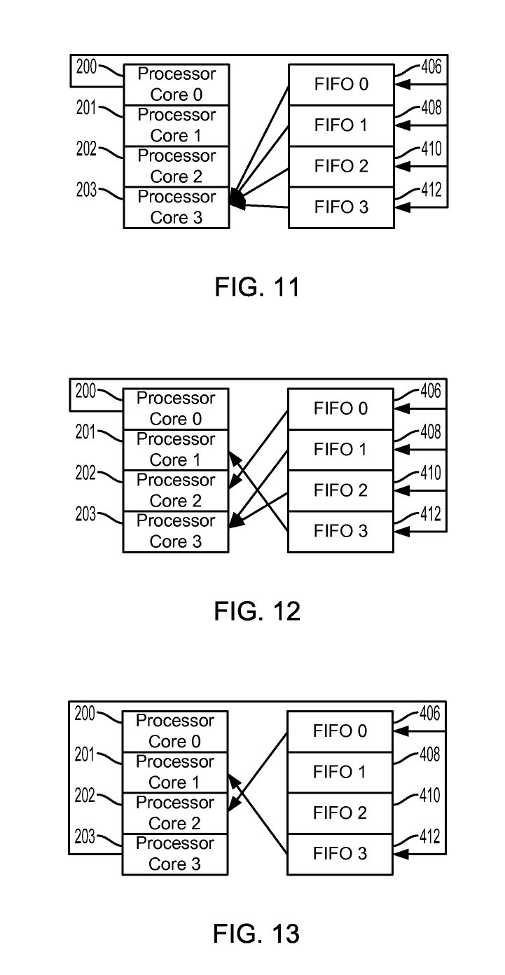

FIG. 11 illustrates a one-to-many write allocation between the processor core 200 and the FIFO components 406, 408, 410, and 412, and a many-to-one read allocation between the FIFO components 406, 408, 410, and 412 and the processor core 203.

FIG. 12 illustrates a one-to-many write allocation between the processor core 200 and the FIFO components 406, 408, 410, and 412, and a combination of one-to-one and many-to-one read allocations between the FIFO components 406, 408, 410, and 412 and the processor cores 201, 202, and 203.

FIG. 13 illustrates a one-to-many write allocation between the processor core 203 and the FIFO components 406 and 412, and one-to-one read allocations between the FIFO components 406 and 412 and the processor cores 201 and 202.

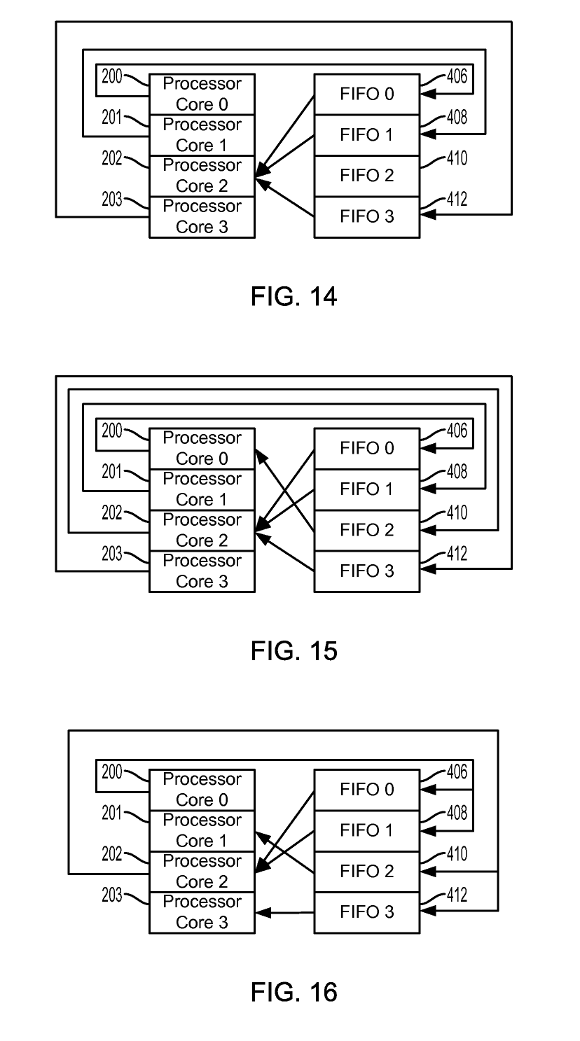

FIG. 14 illustrates one-to-one write allocations between the processor cores 200, 201, and 203 and the FIFO components 406, 408, and 412, and a many-to-one read allocation between the FIFO components 406, 408, and 412 and the processor core 202.

FIG. 15 illustrates one-to-one write allocations between the processor cores 200, 201, 202, and 203 and the FIFO components 406, 408, 410, and 412, and a combination of one-to-one and many-to-one read allocations between the FIFO components 406, 408, 410, and 412 and the processor cores 200 and 202.

FIG. 16 illustrates one-to-many write allocations between the processor cores 200 and 202 and the FIFO components 406, 408, 410, and 412, and a combination of one-to-one and many-to-one read allocations between the FIFO components 406, 408, 410, and 412 and the processor cores 201, 202, and 203.

Note, that the examples of the allocations described above do not necessarily require that all of the processor cores 200, 201, 202, and 204 and/or all of the FIFO components 406, 408, 410, and 412 be allocated. As noted above, these examples are not meant to be limiting as to the number processor cores or FIFO components, or as to the allocations that may exist between the processor cores and FIFO components.

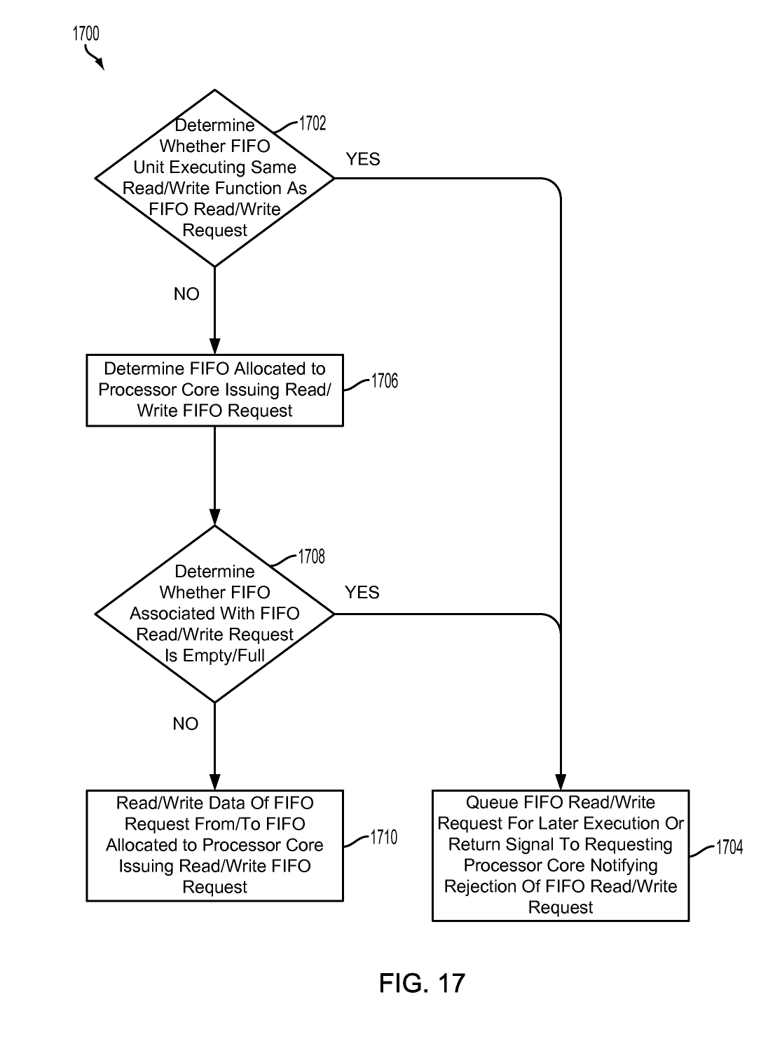

FIG. 17 illustrates an aspect method 1700 for avoiding deadlock for variably implementing a pipeline multi-processing mode. The method 1700 may be executed in a computing device using software, general purpose or dedicated hardware, or a combination of software and hardware. In determination block 1702, the common FIFO unit may determine whether the common FIFO unit is executing a same function, i.e. read or write, as a received read or write FIFO request from a processor core. In making this determination, the read or write function being executed by the common FIFO unit does not have to have originated from the same processor core that is issuing the current read or write FIFO request. As described above, the common FIFO unit may only be able to handle one of each of a read function and a write function at a time. In an aspect, this may be a result of only having one read input/output port and one write input/output port.

In response to determining that the common FIFO unit is executing a same function, i.e. read or write, as a received read or write FIFO request from a processor core (i.e. determination block 1702=“Yes”), the common FIFO unit may handle the conflicting read or write FIFO requests in block 1704. In an aspect, the common FIFO unit may queue the later read or write FIFO request for execution when the common FIFO unit has completed the execution of the earlier conflicting function and is ready to execute the queued request. The later read or write function request may be queued by the common FIFO unit in a memory device internal or external to the common FIFO unit. In an aspect, the common FIFO unit may generate a return signal and send it to the request issuing processor core to notify that its issued request is denied. The return signal may be sent to the processor core via the common communication bus, or via dedicated signaling lines.

In response to determining that the common FIFO unit is not executing a same function, i.e. read or write, as a received read or write FIFO request from a processor core (i.e. determination block 1702=“No”), the common FIFO unit may determine the FIFO component allocated to the processor core issuing the read or write FIFO request in block 1706. Block 1706 may be implemented in the same way as optional block 808 in FIG. 8 described above.

In determination block 1708 the common FIFO unit may determine whether the FIFO component allocated to the processor core for the issued read or write FIFO request is empty (for a read FIFO request) or full (for a write FIFO request). In an aspect, the common FIFO unit may assess the state of the allocated FIFO component. In response to a read FIFO request, the common FIFO component may check to see whether the state of the allocated FIFO component is empty or has data. An empty FIFO component may not contain any data to satisfy the read FIFO request. In response to a write FIFO request, the common FIFO component may check to see whether the state of the allocated FIFO component is full or has space. A full FIFO component may not have any space to satisfy the write FIFO request.

In response to determining that the FIFO component allocated to the processor core for the issued read or write FIFO request is empty (for a read FIFO request) or full (for a write FIFO request) (i.e. determination block 1708=“Yes”), the common FIFO unit may handle the conflicting read or write FIFO requests in block 1704. In an aspect the, the common FIFO unit may queue the read FIFO request for execution until the allocated FIFO component inputs data that may be used to satisfy the read FIFO request. The common FIFO unit may queue the write FIFO request for execution until the allocated FIFO component outputs data that may make space that could be used to satisfy the write FIFO request. In an aspect, the common FIFO unit may generate a return signal and send it to the request issuing processor core to notify that its issued request is denied as described above.

In response to determining that the that the FIFO component allocated to the processor core for the issued read or write FIFO request is not empty (for a read FIFO request) or not full (for a write FIFO request) (i.e. determination block 1708=“No”), the common FIFO unit may read data from or write data to the FIFO component allocated to the processor core issuing the read or write FIFO request in block 1710.

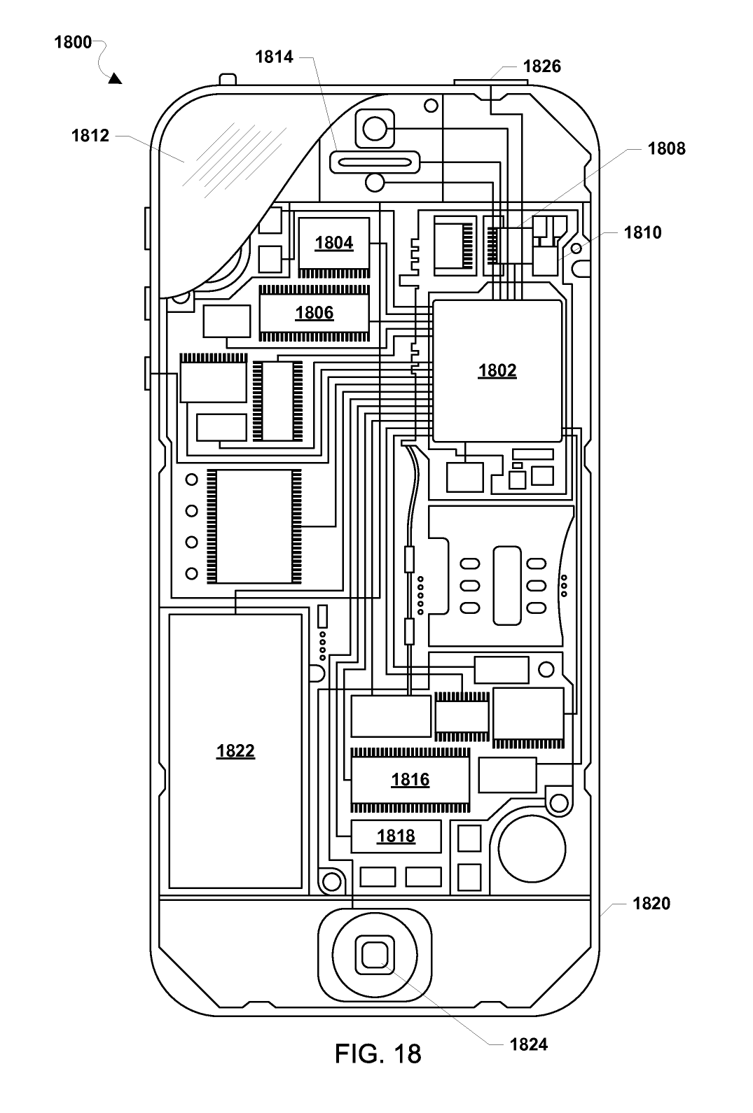

FIG. 18 illustrates an example mobile device suitable for use with the various aspects. The mobile device 1800 may include a processor 1802 coupled to a touchscreen controller 1804 and an internal memory 1806. The processor 1802 may be one or more multicore integrated circuits allocated to general or specific processing tasks. The internal memory 1806 may be volatile or non-volatile memory, and may also be secure and/or encrypted memory, or unsecure and/or unencrypted memory, or any combination thereof. Examples of memory types which can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1804 and the processor 1802 may also be coupled to a touchscreen panel 1812, such as a resistive-sensing touchscreen, capacitive-sensing touchscreen, infrared sensing touchscreen, etc. Additionally, the display of the computing device 1800 need not have touch screen capability.

The mobile device 1800 may have one or more radio signal transceivers 1808 (e.g., Peanut, Bluetooth, Zigbee, Wi-Fi, RF radio) and antennae 1810, for sending and receiving communications, coupled to each other and/or to the processor 1802. The transceivers 1808 and antennae 1810 may be used with the above-mentioned circuitry to implement the various wireless transmission protocol stacks and interfaces. The mobile device 1800 may include a cellular network wireless modem chip 1816 that enables communication via a cellular network and is coupled to the processor.

The mobile device 1800 may include a peripheral device connection interface 1818 coupled to the processor 1802. The peripheral device connection interface 1818 may be singularly configured to accept one type of connection, or may be configured to accept various types of physical and communication connections, common or proprietary, such as USB, FireWire, Thunderbolt, or PCIe. The peripheral device connection interface 1818 may also be coupled to a similarly configured peripheral device connection port (not shown).

The mobile device 1800 may also include speakers 1814 for providing audio outputs. The mobile device 1800 may also include a housing 1820, constructed of a plastic, metal, or a combination of materials, for containing all or some of the components discussed herein. The mobile device 1800 may include a power source 1822 coupled to the processor 1802, such as a disposable or rechargeable battery. The rechargeable battery may also be coupled to the peripheral device connection port to receive a charging current from a source external to the mobile device 1800. The mobile device 1800 may also include a physical button 1824 for receiving user inputs. The mobile device 1800 may also include a power button 1826 for turning the mobile device 1800 on and off.

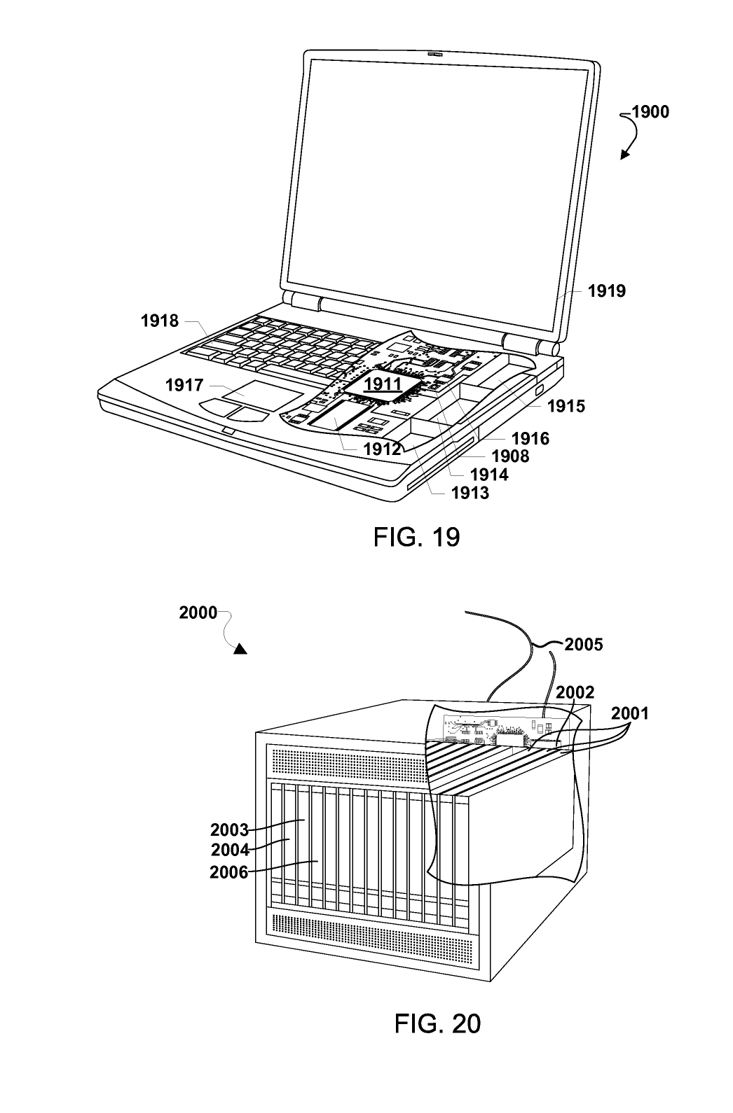

The various aspects described above may also be implemented within a variety of mobile devices, such as a laptop computer 1900 illustrated in FIG. 19. Many laptop computers include a touchpad touch surface 1917 that serves as the computer's pointing device, and thus may receive drag, scroll, and flick gestures similar to those implemented on computing devices equipped with a touch screen display and described above. A laptop computer 1900 will typically include a processor 1911 coupled to volatile memory 1912 and a large capacity nonvolatile memory, such as a disk drive 1913 of Flash memory. Additionally, the computer 1900 may have one or more antenna 1908 for sending and receiving electromagnetic radiation that may be connected to a wireless data link and/or cellular telephone transceiver 1916 coupled to the processor 1911. The computer 1900 may also include a floppy disc drive 1914 and a compact disc (CD) drive 1915 coupled to the processor 1911. In a notebook configuration, the computer housing includes the touchpad 1917, the keyboard 1918, and the display 1919 all coupled to the processor 1911. Other configurations of the computing device may include a computer mouse or trackball coupled to the processor (e.g., via a USB input) as are well known, which may also be used in conjunction with the various aspects.

The various aspects may also be implemented on any of a variety of commercially available server devices, such as the server 2000 illustrated in FIG. 20. Such a server 2000 typically includes one or more multi-core processor assemblies 2001 coupled to volatile memory 2002 and a large capacity nonvolatile memory, such as a disk drive 2004. As illustrated in FIG. 20, multi-core processor assemblies 2001 may be added to the server 2000 by inserting them into the racks of the assembly. The server 2000 may also include a floppy disc drive, compact disc (CD) or DVD disc drive 2006 coupled to the processor 2001. The server 2000 may also include network access ports 2003 coupled to the multi-core processor assemblies 2001 for establishing network interface connections with a network 2005, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many computing devices operating system kernels are organized into a user space (where non-privileged code runs) and a kernel space (where privileged code runs). This separation is of particular importance in Android and other general public license (GPL) environments where code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method for implementing a pipeline multi-processing mode within a computing device, comprising:
receiving configuration information for the pipeline multi-processing mode at a common first in, first out (FIFO) unit having a plurality of FIFO components;
allocating a first FIFO component of the plurality of FIFO components to a first processor core for executing a first function including one of inputting write data or outputting read data in accordance with the received configuration information such that the first FIFO component is also allocated to a second processor core for executing a second function including the other of inputting write data or outputting read data;
receiving FIFO access requests from the first and second processor cores; and
executing the first and second functions using the allocated FIFO component in response to receiving FIFO access requests from the first and second processor cores.

2. The method of claim 1, further comprising:
allocating a second FIFO component of the plurality of FIFO components to the first processor core for executing the first function in accordance with the received configuration information; and
allocating the second FIFO component to the second processor core for executing the second function in accordance with the configuration information.

3. The method of claim 1, further comprising:
allocating a second FIFO component of the plurality of FIFO components to a third processor core for a third function including one of inputting write data or outputting read data in accordance with the received configuration information such that the first function and the third function both include the same of inputting write data or outputting read data, and such that the second FIFO component is also allocated to the second processor core for executing the second function.

4. The method of claim 1, wherein the FIFO access requests each specify one of inputting write data or outputting read data, and wherein receiving FIFO access requests from the first and second processor cores comprises:
receiving a first FIFO access request from the first or second processor core;
determining whether the common FIFO component can handle a first FIFO access request; and
denying the first FIFO access request in response to determining that the common FIFO component cannot handle the first FIFO access request.

5. The method of claim 4, wherein determining whether the common FIFO component can handle a first FIFO access request comprises:
determining whether the common FIFO unit is already executing a second FIFO access request such that the first and second FIFO access requests specify the same one of inputting write data or outputting read; and
determining that the common FIFO unit cannot handle the first FIFO access request in response to determining that the common FIFO unit is already executing the second FIFO access request specifying the same one of inputting write data or outputting read as the first FIFO access request.

6. The method of claim 4, wherein determining whether the common FIFO component can handle a first FIFO access request comprises:
determining an allocated FIFO component for a processor core issuing the first FIFO access request;
determining whether the allocated FIFO component contains data in response to the first FIFO access request specifying outputting read data;
determining whether the allocated FIFO component is full in response to the first FIFO access request specifying inputting write data; and
determining that the common FIFO component cannot handle the first FIFO access request in response to determining the allocated FIFO component does not contain data or the allocated FIFO component is full.

7. The method of claim 4, wherein denying the first FIFO access request in response to determining that the common FIFO component cannot handle the first FIFO access request comprises:
generating a return signal configured to notify a processor core issuing the first FIFO access request that the first FIFO access request is denied.

8. The method of claim 1, further comprising:
receiving further configuration information for the pipeline multi-processing mode at the common FIFO unit;
allocating the first FIFO component to a third processor core for executing a third function including one of inputting write data or outputting read data in accordance with the received further configuration information, such that allocating the first FIFO component to the third processor core replaces allocating the first FIFO component to the first processor core, and such that the first FIFO component is also allocated to the second processor core for executing the second function including the other of inputting write data or outputting read data;
receiving FIFO access requests from the second and third processor cores; and
executing the second and third functions using the allocated first FIFO component in response to receiving FIFO access requests from the second and third processor cores.

9. A computing device, comprising:
a plurality of processor cores; and
a common first in, first out (FIFO) unit comprising a plurality of FIFO components and a switch configure to allocate selected FIFO components to selected processor cores, wherein the FIFO unit is configure to perform operations comprising:
receiving configuration information for a pipeline multi-processing mode;
allocating a first FIFO component of the plurality of FIFO components to a first processor core of the plurality of processor cores for executing a first function including one of inputting write data or outputting read data in accordance with the received configuration information such that the first FIFO component is also allocated to a second processor core of the plurality of processor cores for executing a second function including the other of inputting write data or outputting read data;
receiving FIFO access requests from the first and second processor cores; and
executing the first and second functions using the allocated FIFO component in response to receiving FIFO access requests from the first and second processor cores.

10. The computing device of claim 9, wherein the FIFO unit is configure to perform operations further comprising:
allocating a second FIFO component of the plurality of FIFO components to the first processor core for executing the first function in accordance with the received configuration information; and
allocating the second FIFO component to the second processor core for executing the second function in accordance with the configuration information.

11. The computing device of claim 9, wherein the FIFO unit is configure to perform operations further comprising:
allocating a second FIFO component of the plurality of FIFO components to a third processor core for a third function including one of inputting write data or outputting read data in accordance with the received configuration information such that the first function and the third function both include the same of inputting write data or outputting read data, and such that the second FIFO component is also allocated to the second processor core for executing the second function.

12. The computing device of claim 9, wherein the FIFO access requests each specify one of inputting write data or outputting read data, and wherein the FIFO unit is configure to perform operations such that receiving FIFO access requests from the first and second processor cores comprises:
receiving a first FIFO access request from the first or second processor core;
determining whether the common FIFO component can handle a first FIFO access request; and
denying the first FIFO access request in response to determining that the common FIFO component cannot handle the first FIFO access request.

13. The computing device of claim 12, wherein the FIFO unit is configure to perform operations such that determining whether the common FIFO component can handle a first FIFO access request comprises:
determining whether the common FIFO unit is already executing a second FIFO access request such that the first and second FIFO access requests specify the same one of inputting write data or outputting read; and
determining that the common FIFO unit cannot handle the first FIFO access request in response to determining that the common FIFO unit is already executing the second FIFO access request specifying the same one of inputting write data or outputting read as the first FIFO access request.

14. The computing device of claim 12, wherein the FIFO unit is configure to perform operations such that determining whether the common FIFO component can handle a first FIFO access request comprises:
determining an allocated FIFO component for a processor core issuing the first FIFO access request;
determining whether the allocated FIFO component contains data in response to the first FIFO access request specifying outputting read data;
determining whether the allocated FIFO component is full in response to the first FIFO access request specifying inputting write data; and
determining that the common FIFO component cannot handle the first FIFO access request in response to determining the allocated FIFO component does not contain data or the allocated FIFO component is full.

15. The computing device of claim 12, wherein the FIFO unit is configure to perform operations such that denying the first FIFO access request in response to determining that the common FIFO component cannot handle the first FIFO access request comprises:
generating a return signal configured to notify a processor core issuing the first FIFO access request that the first FIFO access request is denied.

16. The computing device of claim 9, wherein the FIFO unit is configure to perform operations further comprising:
receiving further configuration information for the pipeline multi-processing mode;
allocating the first FIFO component to a third processor core of the plurality of processor cores for executing a third function including one of inputting write data or outputting read data in accordance with the received further configuration information, such that allocating the first FIFO component to the third processor core replaces allocating the first FIFO component to the first processor core, and such that the first FIFO component is also allocated to the second processor core for executing the second function including the other of inputting write data or outputting read data;
receiving FIFO access requests from the second and third processor cores; and
executing the second and third functions using the allocated FIFO component in response to receiving FIFO access requests from the second and third processor cores.

17. A computing device, comprising:
a plurality of processor cores;
a common first in, first out (FIFO) unit comprising a plurality of FIFO components;
means for receiving configuration information for a pipeline multi-processing mode;
means for allocating a first FIFO component of the plurality of FIFO components to a first processor core of the plurality of processor cores for executing a first function including one of inputting write data or outputting read data in accordance with received configuration information such that the first FIFO component is also allocated to a second processor core of the plurality of processor cores for executing a second function including the other of inputting write data or outputting read data;
means for receiving FIFO access requests from the first and second processor cores; and
means for executing the first and second functions using the allocated FIFO component in response to receiving FIFO access requests from the first and second processor cores.

18. The computing device of claim 17, further comprising:
means for allocating a second FIFO component of the plurality of FIFO components to the first processor core for executing the first function in accordance with received configuration information; and
means for allocating the second FIFO component to the second processor core for executing the second function in accordance with the configuration information.

19. The computing device of claim 17, further comprising:
means for allocating a second FIFO component of the plurality of FIFO components to a third processor core for a third function including one of inputting write data or outputting read data in accordance with received configuration information such that the first function and the third function both include the same of inputting write data or outputting read data, and such that the second FIFO component is also allocated to the second processor core for executing the second function.

20. The computing device of claim 17, wherein the FIFO access requests each specify one of inputting write data or outputting read data, and wherein means for receiving FIFO access requests from the first and second processor cores comprises:
means for receiving a first FIFO access request from the first or second processor core;
means for determining whether the common FIFO component can handle a first FIFO access request; and
means for denying the first FIFO access request in response to determining that the common FIFO component cannot handle the first FIFO access request.

21. The computing device of claim 20, wherein means for determining whether the common FIFO component can handle a first FIFO access request comprises:
means for determining whether the common FIFO unit is already executing a second FIFO access request such that the first and second FIFO access requests specify the same one of inputting write data or outputting read; and
means for determining that the common FIFO unit cannot handle the first FIFO access request in response to determining that the common FIFO unit is already executing the second FIFO access request specifying the same one of inputting write data or outputting read as the first FIFO access request.

22. The computing device of claim 20, wherein means for determining whether the common FIFO component can handle a first FIFO access request comprises:
means for determining an allocated FIFO component for a processor core issuing the first FIFO access request;
means for determining whether the allocated FIFO component contains data in response to the first FIFO access request specifying outputting read data;
means for determining whether the allocated FIFO component is full in response to the first FIFO access request specifying inputting write data; and
means for determining that the common FIFO component cannot handle the first FIFO access request in response to determining the allocated FIFO component does not contain data or the allocated FIFO component is full.

23. The computing device of claim 20, wherein means for denying the first FIFO access request in response to determining that the common FIFO component cannot handle the first FIFO access request comprises:
means for generating a return signal configured to notify a processor core issuing the first FIFO access request that the first FIFO access request is denied.

24. The computing device of claim 17, further comprising:
means for receiving further configuration information for the pipeline multi-processing mode;
means for allocating the first FIFO component to a third processor core of the plurality of processor cores for executing a third function including one of inputting write data or outputting read data in accordance with received further configuration information, such that allocating the first FIFO component to the third processor core replaces allocating the first FIFO component to the first processor core, and such that the first FIFO component is also allocated to the second processor core for executing the second function including the other of inputting write data or outputting read data;
means for receiving FIFO access requests from the second and third processor cores; and
means for executing the second and third functions using the allocated FIFO component in response to receiving FIFO access requests from the second and third processor cores.

25. A non-transitory processor-readable medium having stored thereon processor-executable instructions configured to cause a processor coupled to a common first in, first out (FIFO) unit comprising a plurality of FIFO components to perform operations comprising:
receiving configuration information for a pipeline multi-processing mode;
allocating a first FIFO component of the plurality of FIFO components to a first processor core for executing a first function including one of inputting write data or outputting read data in accordance with the received configuration information such that the first FIFO component is also allocated to a second processor core for executing a second function including the other of inputting write data or outputting read data;
receiving FIFO access requests from the first and second processor cores; and
executing the first and second functions using the allocated FIFO component in response to receiving FIFO access requests from the first and second processor cores.

26. The non-transitory processor-readable medium of claim 25, wherein the stored processor-executable instructions are configured to cause the processor coupled to the common FIFO unit to perform operations further comprising:
allocating a second FIFO component of the plurality of FIFO components to the first processor core for executing the first function in accordance with the received configuration information; and
allocating the second FIFO component to the second processor core for executing the second function in accordance with the configuration information.

27. The non-transitory processor-readable medium of claim 25, wherein the stored processor-executable instructions are configured to cause the processor coupled to the common FIFO unit to perform operations further comprising:
allocating a second FIFO component of the plurality of FIFO components to a third processor core for a third function including one of inputting write data or outputting read data in accordance with the received configuration information such that the first function and the third function both include the same of inputting write data or outputting read data, and such that the second FIFO component is also allocated to the second processor core for executing the second function.

28. The non-transitory processor-readable medium of claim 25, wherein the FIFO access requests each specify one of inputting write data or outputting read data, and wherein the stored processor-executable instructions are configured to cause the processor coupled to the common FIFO unit to perform operations such that receiving FIFO access requests from the first and second processor cores comprises:
receiving a first FIFO access request from the first or second processor core;
determining whether the common FIFO component can handle a first FIFO access request; and
denying the first FIFO access request in response to determining that the common FIFO component cannot handle the first FIFO access request.

29. The non-transitory processor-readable medium of claim 28, wherein the stored processor-executable instructions are configured to cause the processor coupled to the common FIFO unit to perform operations such that determining whether the common FIFO component can handle a first FIFO access request comprises:
determining whether the common FIFO unit is already executing a second FIFO access request such that the first and second FIFO access requests specify the same one of inputting write data or outputting read; and
determining that the common FIFO unit cannot handle the first FIFO access request in response to determining that the common FIFO unit is already executing the second FIFO access request specifying the same one of inputting write data or outputting read as the first FIFO access request.

30. The non-transitory processor-readable medium of claim 28, wherein the stored processor-executable instructions are configured to cause the processor coupled to the common FIFO unit to perform operations such that determining whether the common FIFO component can handle a first FIFO access request comprises:
determining an allocated FIFO component for a processor core issuing the first FIFO access request;
determining whether the allocated FIFO component contains data in response to the first FIFO access request specifying outputting read data;
determining whether the allocated FIFO component is full in response to the first FIFO access request specifying inputting write data; and
determining that the common FIFO component cannot handle the first FIFO access request in response to determining the allocated FIFO component does not contain data or the allocated FIFO component is full.
